(19) United States
(12) Patent Application Publication
(10) Pub. No.: US 2006/0187761 A1
(43) Pub. Date: Aug. 24, 2006

(54) Gear mechanism of timepiece, hand winding mechanism and timepiece having the same

(76) Inventors: Takashi Ito, Chiba-shi (JP); Kazumichi Obara, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/353,614

(22) Filed: Feb. 14, 2006

(30) Foreign Application Priority Data
Feb. 21, 2005 (JP) 2005-043301
Dec. 28, 2005 (JP) 2005-378106

(51) Int. Cl. G04B 1/00

(52) U.S. Cl. 368/139

(57) ABSTRACT

To provide a gear mechanism and a hand winding mechanism of a timepiece capable of minimizing a deterioration in an operating function of a wheel having a pivoting shaft. A gear mechanism of a timepiece includes a gear structure member having a pinion portion rotated around a center axis line, a pivoting support member having a long hole extended in a circular arc shape centering on an axis line, a pivoting member in a circular shape an outer periphery of a cross-sectional face of which centers on a center axis line and a constitution loosely fitted to the long hole rotatably centering on the axis line and movably along a circular arc of the long hole, a gear structure member having a gear portion fitted to the pivoting member to be able to rotate slidably and brought in mesh with a gear portion, and a gear structure member having a gear portion brought in mesh with the gear portion disposed at a mesh position P1 at which the pivoting member is disposed on a side of one end of the long hole and released from being brought in mesh with the gear portion disposed at a nonmesh position at which the pivoting member is disposed on a side of other end of the long hole.

### BACKGROUND OF THE INVENTION

1. Field of the Invention

The present invention relates to a gear mechanism of a timepiece such as a hand winding mechanism and a timepiece having the same.

2. Description of the Prior Art

In a timepiece having both of an automatic winding mechanism and a hand winding mechanism of a mainspring, there is known a hand winding mechanism including a crown wheel having a crown gear rotated around a first rotation center axis line in accordance with rotation of a winding stem in one direction in hand winding, a pivoting support member having a long hole extended in a circular arc shape centering on the first rotation center axis line, a pivoting crown wheel having a shaft portion loosely fitted to the long hole movably along the circular arc of the long hole and rotatable around a center axis line thereof and a pivoting crown gear fixed to the shaft portion, and a transmission wheel having a transmission gear portion brought in mesh with the pivoting crown gear when the shaft portion is disposed at a mesh position disposed on one end side of the long hole and released from being brought in mesh with the pivoting crown gear when the shaft portion is disposed at a nonmesh position disposed on other end side of the long hole, the transmission gear portion being coupled to a ratchet wheel (for example, JP-A-11-174163 and JP-A-2003-279667). Further, in the case of JP-A-2003-279667, the transmission wheel is disposed between the crown wheel and the pivoting crown wheel and the pivoting crown wheel is made to be able to be directly brought in mesh with a ratchet wheel. In either of the cases, when an automatic winding mechanism is operated, the pivoting crown wheel is set to the nonmesh position to avoid a torque of the automatic winding mechanism from being transmitted to the winding stem side.

However, according to the hand winding mechanism of this kind, there is a concern that a load by a winding torque is applied on the shaft of the pivoting crown wheel to wear a peripheral face of the long hole operated as a bearing of the shaft, pivoting performance of the pivoting crown wheel is deteriorated, a resistance against rotation of the pivoting crown wheel is increased, and the torque required for winding is increased.

The invention has been carried out in view of the above-described problem and it is an object thereof to provide a gear mechanism of a timepiece, a hand winding mechanism and a timepiece having the same capable of minimizing a deterioration in a function of operating a wheel having a pivoting shaft as in a pivoting crown wheel.

### SUMMARY OF THE INVENTION

In order to achieve the above-described object, a gear mechanism of a timepiece of the invention comprises a first gear structure member having a first gear portion rotated around a first rotation center axis line, a pivoting support member having a long hole extended in a shape of a circular arc centering on the first rotation center axis line, a pivoting member in a circular shape an outer periphery of a cross-sectional face of which centers on a second center axis line and which is loosely fitted to the long hole rotatably centering on the second rotation center axis line and movably along the circular arc of the long hole, a second gear structure member having a second gear portion fitted to the pivoting member to be able to rotate slidably and brought in mesh with the first gear portion, and a third gear structure member having a third gear portion brought in mesh with the second gear portion when the pivoting member is disposed at a mesh position disposed on one end side of the long hole and released from being brought in mesh with the second gear portion when the pivoting member is disposed at a nonmesh position disposed on other end side of the long hole.

According to the gear mechanism of a timepiece of the invention, the second gear structure member pivotable along the long hole in the shape of the circular arc centering on the first rotation center axis line is provided between the first and the third gear structure members and therefore, when the second gear portion of the second gear structure member is disposed at the mesh position, rotation or torque is transmitted between the first gear portion and the third gear portion and when the second gear portion is disposed at the nonmesh position, transmission of rotation or torque between the first gear portion and the third gear portion is released.

The gear mechanism of a timepiece of the invention is particular provided with “the pivoting member in the circular shape the outer periphery of the cross-sectional face of which centers on the second rotation center axis line and which is loosely fitted to the long hole rotatably centering on the second center axis line and movably along the circular arc of the long hole of the pivoting support member” and therefore, the pivoting member serves as a roller and is movable along the long hole by being actually rolled along the long hole in the circular arc shape. Further, “the second gear structure member is fitted to the sliding member to be able to rotate slidably” and therefore, when the pivoting member is rolled along a peripheral face of the long hole, the pivoting member is slid to rotate coaxially with the first gear structure along the long hole and therefore, the second gear structure member can be pivoted while drawing a locus on a concentric circle centering on the first gear along the long hole. Further, when the second gear structure member is pivoted, the pivoting member can be pivoted or rolled along the hole independently from a state of rotating the second gear structure member around the second rotation center axis line. In addition thereto, when the second gear structure member is rotated around a center axis line (second rotation center axis line) of a shaft portion thereof at the mesh position or the like, the pivoting member serves as a kind of a sliding bearing in a state of being actually stationary and supports sliding rotation of the shaft portion of the second gear structure member. Therefore, according to the gear mechanism of the invention, a resistance against rotation and pivoting of the second gear structure member is minimized by the pivoting member, wear of a peripheral face (peripheral wall) of the long hole or the shaft or the like is minimized and therefore, the gear mechanism can be operated stably for a long period of time in a state of a high efficiency of transmitting rotation.

In the above-described, the pivoting member typically comprises:

(1) a bearing member comprising a circular cylinder shape member centering on the second rotation center axis line and loosely fitted to the long hole movably along the circular arc of the long hole, or

(2) a circular column shape member centering on the second rotation center axis line and including a loosely fitted shaft portion loosely fitted to the long hole movably along the circular arc of the long hole and a gear shaft portion fitted to a bearing hole portion of the second gear portion of the second gear structure member to be able to rotate slidably.

Here, the circular cylinder shape member refers to a constitution in which the second rotation center axis line and a vicinity thereof are hollow (constituting a hole) and the circular column shape member refers to a constitution in which the second rotation center axis line at a vicinity thereof is solid (or a hole does not need to be present), in either thereof, an outer diameter thereof differs by a portion in the axis line direction, for example, the constitution can include a flange portion or a portion in a flange-like shape.

In the former case, that is, when the pivoting member comprises the bearing member, the second gear structure member includes the shaft portion fitted to the hole of the circular cylinder of the bearing member and fixed to the second gear portion.

In this case, according to the gear mechanism of a timepiece of the invention, “the bearing member comprising the circular cylinder shape member centering on the second center axis line and loosely fitted to the long hole rotatably centering on the second rotation center axis line and movably along the circular arc of the long hole” is provided as the pivoting member and therefore, the bearing member serves a roller or a wheel and is movable along the long hole by being actually rolled along the long hole in the circular arc shape. Further, “the shaft portion of the second gear structure member is fitted to the hole of the cylinder of the bearing member to be able to rotate slidably” and therefore, when the bearing member in the circular cylinder shape is rolled along the peripheral face of the long hole, the bearing member is engaged with the shaft portion of the second gear structure member to be coaxially rotated slidably and therefore, the second gear structure member can be pivoted while drawing the locus on the concentric circle centering on the first gear along the long hole, in the pivoting, the second gear structure member can be rotated around the second rotation center axis line independently from the pivoting state. Further, when the second gear structure member is rotated around the center axis line (second rotation center axis line) of the shaft portion at the mesh position, the bearing member serves as a sliding bearing in a state of being actually stationary relative to the long hole to support sliding rotation of the shaft portion of the second gear structure member. Therefore, according to the gear mechanism of the invention, the resistance against rotation and pivoting of the second gear structure member can be minimized by the bearing member, wear of the peripheral face (peripheral wall) of the long hole can also be minimized and therefore, the gear mechanism can stably be operated for a long period of time in the state of the high efficiency of transmitting rotation.

On the other hand, in the latter case, that is, when the pivoting member comprises the circular column shape member including the loosely fitted shaft portion and the gear shaft portion, the second gear portion of the second gear structure member includes the bearing hole portion fitted rotatably with the gear shaft portion of the pivoting member to be able to rotate slidably.

In this case, according to the gear mechanism of a timepiece of the invention, “the circular column shape member centering on the second rotation center axis line including the loosely fitted shaft portion loosely fitted to the long hole movably along the circular arc of the long hole and the gear shaft portion fitted to the bearing hole portion of the second gear portion of the second gear structure to be able to rotate slidably” is provided and therefore, the loosely fitted shaft portion of the circular column shape member serves as a roller and is movable along the long hole by being actually rolled along the long hole in the circular arc shape. Further, “the second gear portion of the second gear structure member includes the bearing hole portion fitted to the gear shaft portion of the pivoting member to be able to rotate slidably” and therefore, when the loosely fitted shaft portion of the pivoting member is rolled along the peripheral face of the long hole, the loosely fitted shaft portion is moved along the long hole while being rotated slidably at inside of the bearing hole portion of the second gear portion of the second gear structure member and therefore, the second gear structure member can be pivoted along the long hole while drawing the locus on the concentric circle centering on the first gear, and in the pivoting, the second gear structure member can be rotated around the second rotation center axis line independently from the pivoting state. Further, when the second gear structure member is rotated around the center axis line (second rotation center axis line) at the mesh position, the circular column shape member supports slidable rotation of the bearing hole portion of the second gear portion of the second gear structure member in the state in which the circular column shape member is actually stationary relative to the long hole. Therefore, according to the gear mechanism of the invention, the resistance against rotation and pivoting of the second gear structure member is minimized by the pivoting member, wear of the peripheral face (peripheral wall) of the long hole or the shaft or the like is also minimized and therefore, the gear mechanism can stably be operated for a long period of time in the state of the high efficiency of transmitting rotation.

The pivoting support member having the long hole and the pivoting member (typically, the bearing member or the loosely fitted shaft portion of the circular column shape member) may support one portion (typically, one end side) of the shaft portion (when the pivoting member comprises the bearing member, the shaft portion of the second gear structure member, when the pivoting member comprises the circular column shape member, the gear shaft portion of the pivoting member) for supporting the second gear structure member, or may be supported by a plurality thereof for supporting a plurality of portions of the shaft portion (typically, both end portion sides).

The pivoting member (bearing member or circular column shape member) is typically formed by a material having high wear resistance and high hardness, for example, a jewel, carbon steel or the like can be used. On the other hand, the pivoting support member formed with the long hole is typically formed by a comparatively soft material easy to be worked such as brass or nickel silver (nickel silver).

The gear mechanism of a timepiece of the invention having the above-described characteristics is applicable to, for example, a hand winding mechanism of a timepiece. However, the gear mechanism of a timepiece of the invention may be used for other portion of a calendar corrector or the like.

When the gear mechanism of a timepiece of the invention is used in the hand winding mechanism, for example, the first gear structure member corresponds to a crown wheel, the second gear structure member corresponds to a pivoting crown wheel, and the third gear structure member corresponds to a transmission wheel. Further, the “transmission wheel” may be referred by other kind of name so far as the transmission wheel can transmit a rotational torque to a ratchet wheel. Further, for example, the third gear structure member may comprise the ratchet wheel per se instead of comprising the transmission wheel for transmitting the rotational torque to the ratchet wheel. In that case, the third gear of the third gear structure member comprises a ratchet gear (gear portion of a main body portion of the ratchet wheel). Further, the crown wheel may comprise the crown wheel and one or a plurality of intermediate crown wheels instead of comprising only the single crown wheel. Further, rotation of the crown wheel may be transmitted to the pivoting crown wheel by way of a crown transmission wheel instead of directly transmitting rotation of the crown wheel to the pivoting crown wheel, in this case, the first gear structure member comprises the crown transmission wheel.

That is, in order to achieve the above-described object, a hand winding mechanism of the invention comprises a first gear structure member having a first gear rotated around a first rotation center axis line in accordance with rotation of a winding stem in one direction, a pivoting support member having a long hole extended in a shape of a circular arc centering on the first rotation center axis line, a pivoting member in a circular shape an outer periphery of a cross-sectional face of which centers on a second rotation center axis line and which is loosely fitted to the long hole rotatably centering on the second center axis line and movably along the circular arc of the long hole, a pivoting crown wheel which is a second gear structure member including a pivoting crown gear fitted to the pivoting member to be able to rotate slidably and constituting a second gear portion brought in mesh with the first gear portion, and a third gear structure member including a third gear portion brought in mesh with the pivoting crown gear when the pivoting member is disposed at a mesh position disposed on one end side of the long hole and released from being brought mesh with the pivoting crown gear when the pivoting member is disposed at a nonmesh position disposed on other end side of the long hole and coupled to a ratchet wheel.

According to the hand winding mechanism of the invention, as described above with regard to the gear mechanism of the timepiece, “the pivoting crown wheel gear is fitted to the pivoting member in the circular shape the periphery of the cross-sectional face of which is loosely fitted to the long hole movably along the circular arc of the long hole in the circular arc shape of the pivoting support member to be able to rotate slidably” and therefore, the pivoting member can be pivoted along the long hole of the pivoting crown wheel at the portion of the pivoting member loosely fitted to the long hole of the pivoting support member, and supports the pivoting crown gear to be able to rotate around the second rotation center axis line at the portion fitted to the pivoting crown gear to be able to rotate slidably. That is, pivoting and rotation of the pivoting member at inside of the long hole of the pivoting support member and rotation of the pivoting crown gear around the second center axis line can be supported independently from each other and therefore, wear of the peripheral face of the long hole of the shaft or the like can be minimized from being brought about and the hand winding mechanism is operated atably for a long period of time to be able to promote durability.

That is, according to the hand winding mechanism of the invention, when the sliding member comprises a bearing in a circular cylinder shape, the pivoting member comprises a bearing member which is the cylindrical member centering on the second rotation center axis line and loosely fitted to the long hole movably along the circular arc of the long hole, the pivoting crown wheel (second gear structure member) includes the shaft portion fitted to the hole of the circular cylinder of the bearing member to be able to rotate slidably and fixed to the pivoting crown gear (second gear portion). In this case, as described above with regard to the gear mechanism of the timepiece, “the shaft portion of the pivoting crown wheel is fitted to the hole of the circular cylinder of the bearing member constituting the mode of the circular cylinder shape member loosely fitted to the long hole movably along the circular arc of the long hole in the circular arc shape of the pivoting support member to be able to rotate slidably” and therefore, the bearing member can be pivoted along the long hole of the pivoting crown wheel at the outer peripheral portion and axially supports the pivoting crown wheel to facilitate to rotate around the center axis line of the shaft at the inner peripheral portion of the bearing member and therefore, wear or the like at the shaft portion of the pivoting crown wheel or the peripheral face of the long hole can be minimized from being brought about, and the hand winding mechanism is stably operated for a long period of time to be able to promote durability.

On the other hand, according to the hand winding mechanism of the invention, when the pivoting member is provided with the mode of the circular column shape member, the pivoting crown gear (second gear portion) of the pivoting crown wheel (second gear structure member) includes the bearing hole portion and the pivoting member includes the gear shaft portion which is the circular column shape member centering on the second center axis line including the loosely fitted shaft portion loosely fitted to the long hole movably along the circular arc of the long hole and the gear shaft portion fitted to the pivoting crown gear to be able to rotate slidably. In this case, as described above with regard to the gear mechanism of the timepiece, “the gear portion of the pivoting crown wheel (pivoting crown gear) is fitted to the gear shaft portion of the circular column shape member loosely fitted to the long hole at the loosely fitted shaft portion movably along the circular arc of the long hole in the circular arc shape of the pivoting support member to be able to rotate slidably” and therefore, the circular column shape member enables the pivoting crown wheel to be pivoted along the long hole at the outer peripheral portion of the loosely fitted shaft portion, axially supports the pivoting crown gear such that the pivoting crown gear can easily be rotated around the second rotation center axis line at the outer peripheral portion of the gear shaft portion and therefore, wear or the like at the shaft portion of the circular column shape member supporting the bearing hole portion of the pivoting crown wheel or the pivoting crown wheel of the peripheral face of the long hole can be minimized from being brought about and the hand winding mechanism is operated stably for a long period of time to be able to promote durability.

In the above-described, when the pivoting member comprises a bearing in a circular cylinder shape, the second gear structure member or a pivoting crown wheel typically includes the second gear portion or pivoting crown gear at at least one end of the shaft, and includes the shaft portion for supporting the gear portion and the shaft portion is loosely fitted to the long hole of the pivoting support member by way of the bearing member. However, when desired, shaft portions may be formed on both sides of one gear portion, in that case, at least one shaft portion is loosely fitted to the long hole by way of the bearing member in the circular cylinder shape. That is, at least one shaft portion is fitted to the bearing member in the circular cylinder shape loosely fitted to the long hole to be able to rotate slidably. In that case, both shaft portions may be loosely fitted to the long hole by way of the bearing member in the circular cylinder shape. In that case, the pivoting support member comprises a pair of pivoting support member portions. In this case, when an increase in a number of parts is permitted, disassembling by a unit of a part can be carried out.

Further, when the pivoting member comprises the circular column shape member having the loosely fitted shaft portion and the gear portion, typically, the circular column shape member includes loosely fitted shaft portions on both end sides of the gear shaft portion and the loosely fitted shaft portions on the both end sides are pivotably fitted loosely to the long hole of respectively corresponding pivoting support members. In this case, the second structure member or the gear portion of the pivoting crown wheel, that is, the pivoting crown gear portion is fitted to the gear shaft portion disposed between two of the loosely fitted shaft portions of the circular column shape pivoting member to be able to rotate slidably. In this case, portions of the pivoting support member loosely fitted to respectives of the loosely fitted shaft portions of the both ends (a pair of pivoting support member portions) are separately constituted to constitute a structure by which the respective pivoting support portion members and pivoting members are easily disassembled and therefore, parts can easily be repaired or interchanged. Further, in this case, the pivoting member can be formed by a single integrated member (a plurality of parts may be fixed to each other by fitting or the like) and therefore, pivoting and rotation are stably supported and a number of parts can be avoided from being increased excessively. Further, by removing one pivoting support member portion, the pivoting member can be exposed along the with the pivoting crown wheel and therefore, oil can easily be fed to a sliding contact portion by forming an oil feeding recess portion reaching a bearing hole fitted to the gear shaft portion of the pivoting member of the mode of the circular column shape member at one or both main faces of the moving ratchet gear.

According to the hand winding mechanism of the invention, the third gear portion of the third gear structure member may be coupled to the ratchet wheel directly or indirectly,

(1) the first gear structure member may comprise the crown wheel, the first gear portion may comprise the crown wheel gear, the third gear portion may comprise the transmission gear brought in mesh with the ratchet gear, the third gear structure member may comprise the transmission wheel, or

(2) the first gear portion may comprise the transmission gear brought in mesh with the crown gear, the first gear structure member may comprise the transmission wheel, and the third gear portion may comprise the ratchet gear of the ratchet wheel.

When the hand winding mechanism is integrated to a timepiece such as a wristwatch, the timepiece typically further includes an automatic winding mechanism for rotating the ratchet wheel in the winding direction. In this case, when the ratchet wheel is rotated by the automatic winding mechanism, the pivoting crown wheel is moved to the nonmesh position and rotation of the ratchet wheel by the automatic winding mechanism is permitted. Here, when the third gear portion comprises the transmission wheel as in the former case, the transmission wheel is typically operated also as a wheel at a final stage of the automatic winding mechanism.

### BRIEF DESCRIPTION OF THE SEVERAL VIEWS OF THE DRAWINGS

A preferred form of the present invention is illustrated in the accompanying drawings in which:

FIG. 1 is a plane explanatory view of a hand winding mechanism of a preferable embodiment according to the invention;

FIG. 2 is a sectional explanatory view of a portion of a wristwatch having the hand winding mechanism of FIG. 1;

FIG. 3 show relationship among a long hole and a bearing and a shaft, FIG. 3A enlarges to show the relationship among the long hole and the bearing and the shaft of the hand winding mechanism of FIG. 1 and is a sectional explanatory view taken along a line IIIA-IIIA of FIG. 3B, FIG. 3B is a sectional explanatory view taken along a line IIIB-IIIB of FIG. 3A, FIG. 3C is a sectional explanatory view similar to FIG. 3B of a modified example in which a flange portion of the bearing is disposed on an opposed side;

FIG. 4 is a plane explanatory view showing a portion of a wristwatch having a hand winding mechanism of preferable other embodiment according to the invention;

FIG. 5 is a sectional explanatory view taken along a line V-V of the wristwatch of FIG. 4;

FIG. 6 is a sectional explanatory view enlarging to show a portion of the hand winding mechanism of the wristwatch of FIG. 5 including a pivoting crown wheel (however, a state of rotating and a direction of a section of the pivoting crown wheel differ from those of FIG. 5); and

FIG. 7 is a developed (disassembled) sectional explanatory view for explaining assembling of the portion of the hand winding mechanism of FIG. 6 including the pivoting crown wheel.

### DETAILED DESCRIPTION OF THE PREFERRED EMBODIMENTS

A preferable mode for carrying out the invention will be explained based on a preferable embodiment shown in the attached drawings.

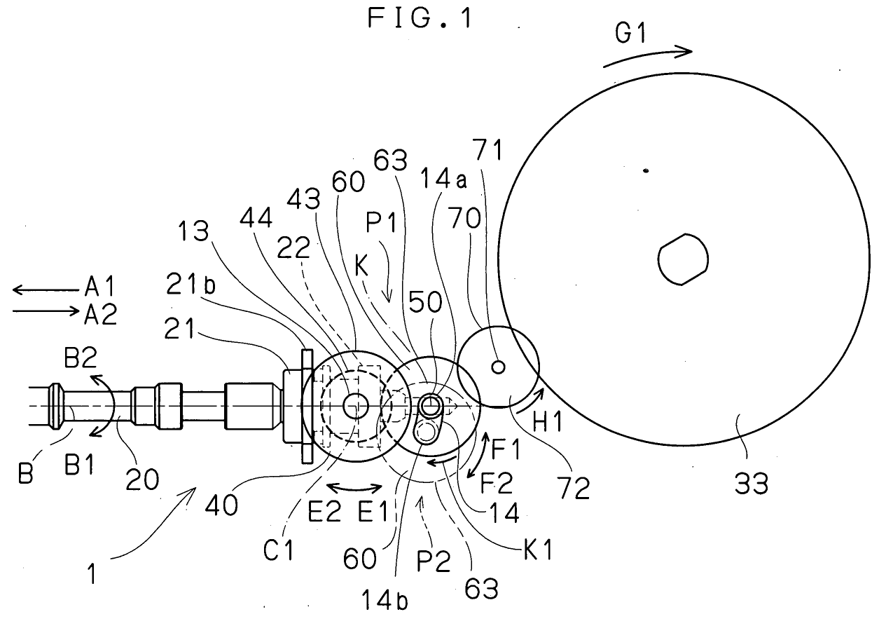

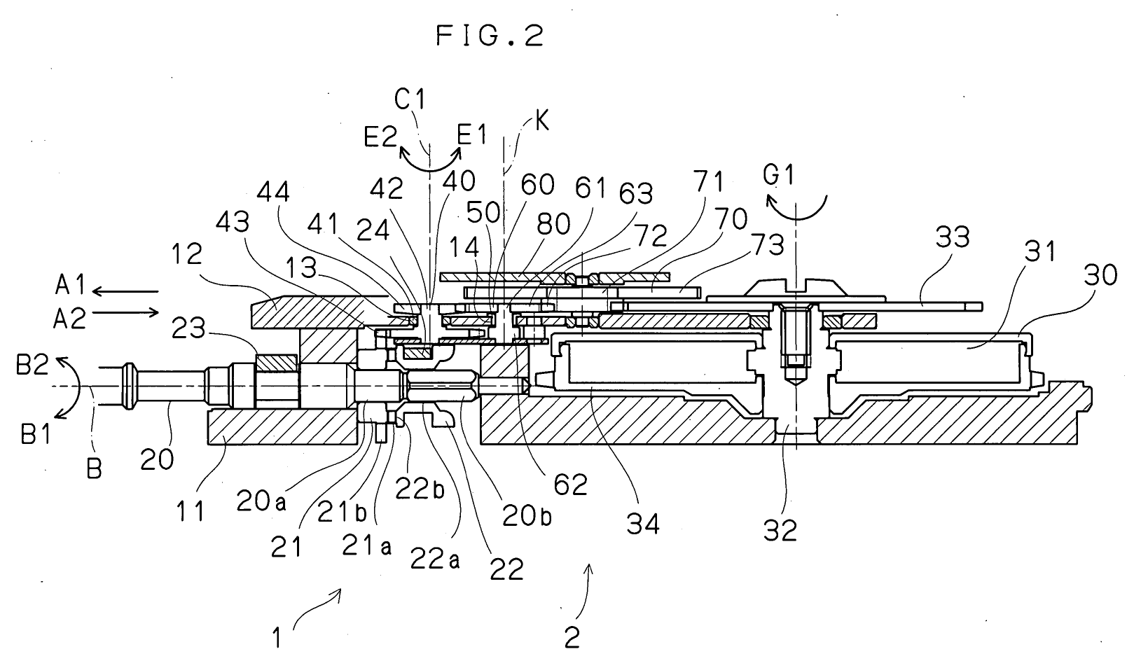

FIG. 1 shows a hand winding mechanism 1 of a preferable embodiment according to the invention, and FIG. 2 shows a wristwatch 2 having the hand winding mechanism 1. The wristwatch 2 includes a main plate 11 and the main plate 11 is arranged with a winding stem 20 to be able to be brought in and out in A1, A2 directions and rotatably in B1, B2 directions around a center axis line B. A barrel 30 is further arranged between the main plate 11 and a first bridge 12. The barrel 30 includes a main spring 31, a barrel stem 32 mounted with an inner end of the mainspring 31, a ratchet wheel 33 fixed to the stem 32 and a barrel complete 34 engaged with an outer end of the mainspring 31. The ratchet wheel 33 is disposed on a top side (case back side) of the first bridge 12.

In FIG. 2, the case back side of the first bridge 12 comprising brass or nickel silver is arranged with an automatic winding mechanism 80 including an oscillating weight, when an attitude of the wristwatch 2 is changed or the wristwatch 2 is moved to be accelerated, the automatic winding mechanism 80 is operated in accordance with the change or the movement to exert a torque in G1 direction by way of a torque transmitting mechanism, not illustrated, (a final stage of which is a second transmission gear 73 of a second transmission wheel 70, mentioned later) to the ratchet wheel 33 to wind the mainspring 31.

A circular cylinder portion 20a of the winding stem 20 is fitted with a winding pinion 21 having a ratchet gear or a claw portion 21a and a gear portion 21b and a square cylinder portion 20b thereof is slidably fitted with a clutch wheel 22 having a square hole 22a and a ratchet claw or a gear portion 22b slidably in A1, A2 directions. When the winding stem 20 is disposed at 0 stage of being pushed in A2 direction, the winding pinion 21 is rotated in B1 direction by way of the ratchet mechanism 22b, 21a in accordance with integral B1 direction rotation of the clutch wheel 22 in accordance with B1 direction rotation of the winding stem 20. When the winding stem 20 is rotated in B2 direction, transmission of B2 direction rotation of the clutch wheel 22 in accordance with rotation of the winding stem 20 is cut by the ratchet mechanism 22b, 21a. Further, when the winding stem 20 is extracted in A1 direction, the clutch wheel 22 is moved in A2 direction by way of a setting lever 23 and a yoke 24 and other operation in accordance with the winding stem extracted position is carried out in accordance with rotation of the winding stem 20.

The first bridge 12 as a pivoting support member is formed with a bearing receive hole 13 and a long hole 14 in a shape of a circular arc. The circular arc of the long hole 14 is a portion of a circle centering on a center axis line C1 of a bearing receive hole 13 as a first rotation center axis line.

The bearing receive hole 13 is fitted with a bearing 41 and the baring 41 is fitted with a shaft portion 42 of a crown wheel 40 to be able to be rotated slidably in E1, E2 directions. The crown wheel 40 is provided with a crown gear 43 brought in mesh with the clutch wheel 21 on one end side of the shaft portion 42 and a crown pinion 44 on other end side of the shaft portion 42. According to the example, the crown gear 43 is integrally formed with the shaft portion 42 and the crown pinion 44 is fitted to the shaft portion.

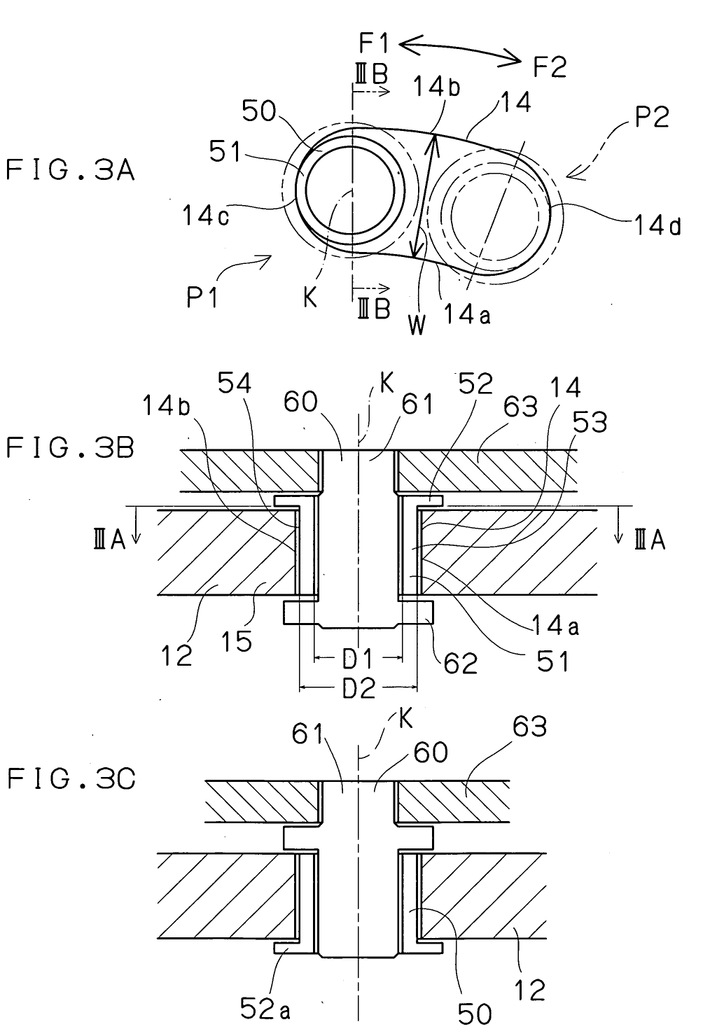

As is known from an enlarged view shown in FIG. 3A, the circular arc shape long hole 14 comprises a circular arc shape opening having a width (length in diameter direction) W and slender in a circumferential direction. Here, the circular arc shape long hole 14 is loosely fitted with a bearing member 50 as a pivoting member comprising a material having high hardness and high wear resistance as in a jewel or carbon steel. The bearing member 50 comprises a cylindrical member 51 having an inner diameter of D1 and an outer diameter of D2 centering on a center axis line K as a second rotation center axis line and is formed with a flange shape portion or a flange portion 52 at one end in an axial direction. A length of a portion of the cylindrical member 51 excluding the flange shape portion 52, that is, a cylinder main body 53 is substantially the same as or smaller than a thickness of a portion 15 of the first bridge 12 formed with the long hole 14. Further, although in FIG. 1 and FIG. 3B, the flange shape portion 52 is disposed on the case back side of the first bridge 12, in consideration of abrasion or wear, as shown by FIG. 3C, a flange shape portion 52a may be formed on a side opposed to a pivoting crown gear 63, that is, on a dial side of the first bridge 12. So far as the bearing member 50 is maintained in a loosely fitted state at inside of the long hole 14, the flange shape portions 52, 52a may not be present. The flange portion 52, 52a is provided such that when the pivoting crown wheel 60 is inclined by play of the bearing portion by the mainspring winding torque of the barrel, a shaft or a tooth tip of the pivoting crown wheel 60 is not brought into direct contact with the first bridge 12 or cut the first bridge 12 and generally, it is preferable that the flange portion 52, 52a is present.

The outer diameter D2 of the bearing member 50 is provided with a size substantially the same as the width W of the circular arc shape long hole 14 and a little smaller than the width W. Therefore, an outer peripheral face 54 of the cylinder main body 53 of the bearing member 50 can be rolled along a peripheral face 14a or 14b while being brought into contact with the peripheral face 14a, 14b of the long hole 14. Therefore, the bearing member 50 can be moved in F1, F2 directions between one end portion 14c and other end portion 14d of the long hole 14 along a direction of extending the long hole 14.

The pivoting crown wheel 60 as a second gear structure member includes a shaft portion 61 fitted to the bearing member 50 to be able to rotate slidably, a large diameter portion 62 formed on one end side of the shaft portion 61, and the pivoting crown gear 63 as a second gear portion fitted to and formed at other end side of the shaft portion 61 and brought in mesh with the crown pinion 44.

The pivoting crown wheel 60 can be pivoted in F1, F2 directions along the circular arc shape long hole 14 along with the bearing member 50 in a state of being brought in mesh with the crown pinion 44 at the pivoting crown gear 63, and takes a mesh position P1 indicated by a bold line in FIG. 1 and FIG. 3A, when the bearing member 50 is disposed at the end portion 14c of the lone hole 14 and takes a nonmesh position P2 indicated by an imaginary line in. FIG. 1 and FIG. 3A when the bearing member 50 is disposed at the end portion 14d of the long hole 14.

The second transmission wheel 70 as a third gear structure member rotatably supported by the first bridge 12 is arranged between the pivoting crown wheel 60 and the ratchet wheel 33. The second transmission wheel 70 includes a second transmission pinion 72 brought in mesh with the ratchet wheel 33 and capable of being brought in mesh with the pivoting crown wheel 60, and the second transmission wheel 73 as a third gear portion receiving a drive force from a drive side portion of the automatic winding mechanism 80 the detail of which is not illustrated.

Further in details, when the pivoting crown wheel 60 takes the mesh position P1 indicated by the bold line, the pivoting crown wheel 60 is brought in mesh with the second transmission pinion 72 at the pivoting crown gear 63, rotation of the crown wheel 40 is transmitted to the ratchet wheel 33 by way of the second transmission wheel 70 to wind the mainspring 31. On the other hand, when the pivoting crown wheel 60 takes the nonmesh position P2 indicated by the imaginary line, the pivoting crown gear 63 of the pivoting crown wheel 60 and the second transmission pinion 72 are released from being brought in mesh with each other. Further, the pivoting crown wheel 60 receives a deviating force in F1 direction to the mesh position P1 by a pivoting crown spring, not illustrated.

When the second transmission gear 73 of the second transmission wheel 70 is rotated in H1 direction by receiving power of an oscillating weight (not illustrated) of the automatic winding mechanism 80, on one side, a torque in G1 direction is applied to the ratchet wheel 33, on other side, when the second transmission wheel 70 is rotated in the H1 direction, the pivoting crown wheel 60 is displaced in F2 direction from the mesh position P1 to the nonmesh position P2 against a spring force of a pivoting crown spring (not illustrated). Therefore, even when the crown wheel 40 or the like is brought into a state of not being rotated, the clutch wheel 33 is rotated in G1 direction without being restricted by the crown wheel 40 or the like and the mainspring 31 is wound by the automatic winding mechanism 80.

Further, in displacing the pivoting crown wheel 60 in F2 direction, the shaft 61 of the pivoting crown wheel 60 is fitted to the bearing 50 and therefore, the shaft 61 can be slidably rotated at an inner peripheral portion of the bearing 50 around the center axis line K independently from displacement along the circular arc shape long hole 14 and therefore, the pivoting crown wheel 60 can easily be displaced along the long hole 14. Further, the bearing 50 comprises the cylindrical member 51 and the outer peripheral portion is loosely fitted to the long hole 14 and therefore, the bearing 50 can be rolled along the peripheral wall 14a or 14b of the long hole 14 (operated as a rolling bearing) and therefore, the displacement of the bearing 50 in F2 direction can be carried out easily. As a result, in winding the mainspring by the automatic winding mechanism, a resistance against transmission of the torque can be minimized and therefore, automatic winding is easy to be carried out efficiently. Further, a concern of wearing the peripheral walls 14a, 14b of the long hole 14 is inconsiderable.

On the other hand, in a state in which the torque in G1 direction by the automatic winding mechanism 80 is not operated, the pivoting crown wheel 60 is displaced from the nonmesh position P2 to the mesh position P1 by an elastic deviation force in F1 direction of the pivoting crown wheel spring (not illustrated). Therefore, when the winding stem 20 is rotated in B1 direction, rotation of the winding stem 20 in B1 direction is transmitted to the crown wheel 40 by way of the clutch wheel 22 and the winding pinion 21, further, rotation of the crown wheel 40 in E1 direction is transmitted to the ratchet wheel 33 by way of rotation of the pivoting crown wheel 60 disposed at the mesh position P1 in K1 direction and rotation of the second transmission wheel 70 in H1 direction to wind the mainspring 31.

Also in displacing the pivoting crown wheel 60 in F1 direction, similar to the above-described case, the shaft 61 of the pivoting crown wheel 60 is fitted to the bearing 50 and therefore, the shaft 61 can be rotated to pivot relative to the bearing 50 around the center axis line K independently from the displacement along the circular arc shape long hole 14 and therefore, the pivoting crown wheel 60 is easy to be displaced along the long hole 14. Further, the bearing 50 comprises the cylindrical member 51 and is loosely fitted to the long hole 14 and therefore, the bearing 50 can be rolled along the peripheral wall 14a or 14b (operated as a rolling bearing) of the long hole 14 and therefore, the bearing 50 can easily be displaced without wearing the peripheral wall 14a, 14b of the long hole 14. As a result, when the mainspring is finished to be wound by the automatic winding mechanism 80, the pivoting crown wheel 60 can be returned from the nonmesh position P2 to the mesh position P1 swiftly and firmly and therefore, in hand winding, when the winding stem 20 starts rotating to wind in B1 direction, immediately (in a state of minimizing to consume initial rotation of the winding stem 20 for displacing the pivoting crown wheel 60 from the position P2 to the position P1), rotation of the winding stem 20 can be used for winding the mainspring. Therefore, the hand winding operation is easy to be carried out efficiently without waste. However, when desired, the pivoting crown wheel 60 may be pivoted to the mesh position P1 in F1 direction by rotating the crown wheel 40 in E1 direction by omitting the pivoting crown spring (not illustrated).

In addition thereto, the shaft 61 of the pivoting crown wheel 60 can slidably be rotated in K1 direction centering on the axis line K at inside of the bearing 50 operated as a sliding bearing and therefore, when the pivoting crown wheel 60 reaches the mesh position P1, rotation of the winding stem 20 in B1 direction can smoothly be transmitted to the ratchet wheel 33 by way of the winding pinion 21, the crown wheel 40, the pivoting crown wheel 60 and the second transmission wheel 70.

Although an explanation has been given of an example for bringing the crown wheel 40 brought into direct contact with the winding pinion 21 into direct contact with the pivoting crown wheel 60, there may be provided one or a plurality of intermediate crown wheels for transmitting rotation of the crown wheel 40 to the pivoting crown wheel 60 between the crown wheel 40 and the pivoting crown wheel 60.

Further, the pivoting wheel may be constituted to transmit rotation of a wheel other than the crown wheel 40 to a wheel other than the ratchet wheel 33 in place of the pivoting crown wheel.

Instead of the constitution in which the pivoting member loosely fitted pivotably to inside of the long hole comprises the bearing member of the mode of the cylindrical member and supports the outer peripheral face of the shaft of the pivoting crown wheel to be able to rotate slidably by the inner peripheral face of the cylindrical shape bearing member, the sliding member may be fitted to a center hole of the pivoting crown wheel by an outer peripheral face of a circular column shaft member comprising a circular column shape member to slidably support the pivoting crown wheel. The pivoting member is loosely fitted slidably to the long hole similarly in either of the cases.

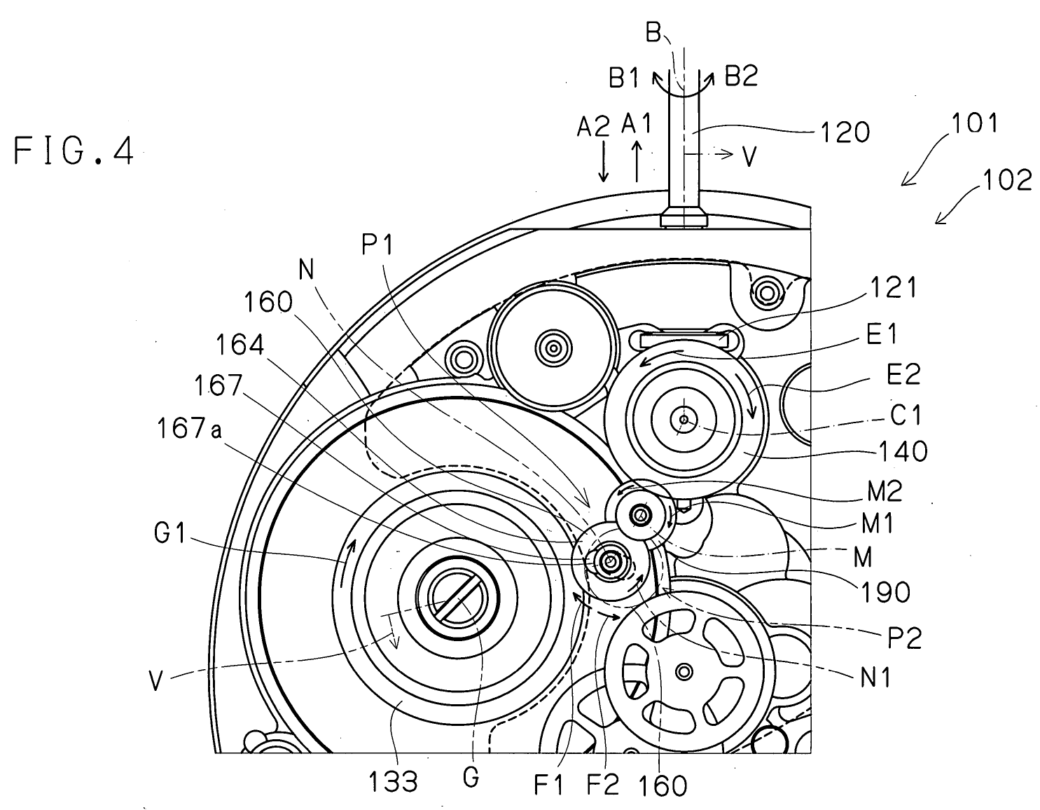

Next, an explanation will be given of a mechanical wristwatch 102 of other preferable embodiment of the invention having a hand winding mechanism 101 of other preferable embodiment of the invention having a sliding member in a circular column shape in reference to FIG. 4 through FIG. 7. In the embodiment shown in FIG. 4 through FIG. 7, members, portions and elements in correspondence with members, portions and elements of the wristwatch 2 shown in FIG. 1 through FIGS. 3A and B are designated by notations constituted by adding “1” to a position of 100 of corresponding notations of members, portions and elements of the wristwatch 2.

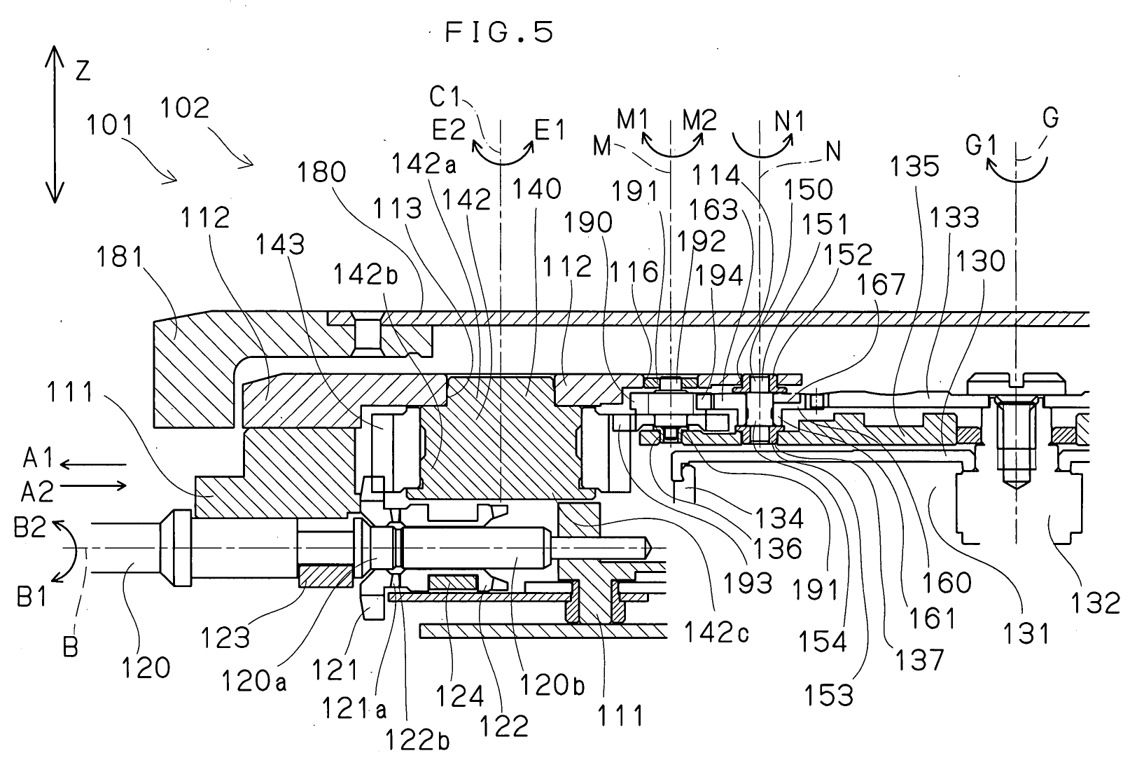

As shown by FIG. 4 and FIG. 5, in the mechanical wristwatch 102 having the hand winding mechanism 101, a main plate 111 is arranged with a winding stem 120 to be able to be brought in and out in A1, A2 directions and rotatably in B1, B2 directions around a center axis line B, and a barrel 130 is rotatably supported by the main plate 111 and a barrel bridge 135. Further, in this example, a third bridge 112 and the barrel bridge 135 are provided separately from each other in place of the first bridge 12. The barrel 130 includes a mainspring 131, a barrel stem 132 stem mounted with an inner end of the mainspring 131, a ratchet wheel 133 fixed to the stem 132, and a barrel complete 134 engaged with an outer end of the mainspring 131. The ratchet wheel 133 is disposed on a top side (case back side) of the barrel bridge 135. In the case of the example, the third bridge 112 and the barrel bridge 135 comprises a comparatively soft metal of brass or nickel silver.

In FIG. 5, a top side (case back side) of the third bridge 112 is arranged with an automatic winding mechanism 180 including an oscillating weight 181, in accordance with a change in an attitude and movement with acceleration of the wristwatch 102, the ratchet wheel 133 is exerted with a torque in G1 direction around a center axis line G by way of a torque transmitting mechanism, not illustrated, to wind the mainspring 131.

Also in the timepiece 102, the winding pinion 121 fitted to a circular cylinder shape portion 120a of the winding stem 120 is engaged with a ratchet claw portion 122b of a clutch wheel 122 engaged with a square cylinder shape portion 120b of the winding stem 120 slidably in an axial direction by a ratchet claw portion 121a, when the winding stem 120 is disposed at 0 stage at which the winding stem 120 is pushed in A2 direction, the winding pinion 121 is rotated in B1 direction in accordance with rotation of the clutch wheel 122 in B1 direction in accordance with rotation of the winding stem 120 in B1 direction. When the winding stem 120 is extracted in A1 direction, the clutch wheel 122 is moved in A2 direction by way of a setting lever 123 and a yoke 124 to release engagement with the winding pinion 121.

According to the hand winding mechanism 101 of the timepiece 102, a pivoting support member comprises the third bridge 112 as a first pivoting support member (portion) and the barrel bridge 135 as a second pivoting support member (portion), that is, the two separate members 112, 135. The third bridge 112 as the first sliding support member is formed with a shaft fitting hole 113 in a circular cylinder shape and a bearing receive hole 116 as well as the long hole 114 in a circular arc shape. The barrel bridge 135 as the second pivoting support member is formed with a bearing receive hole 136 in a circular cylinder shape and a long hole 137 in a circular arc shape. The long holes 114, 137 are provided with the same circular arc shape at positions precisely overlapped to each other in view along a thickness direction Z of the timepiece 102, and circular arcs of the long holes 114, 137 are portions of circles centering on a center axis line M of the bearing receive holes 116, 136 as a first rotation center axis line. The long holes 114, 137 are typically constituted by a size (length W in diameter direction (not illustrated) or the like) and a shape similar to that of the long hole 14 (refer to FIG. 3A) of the hand winding mechanism 1.

The shaft mounting hole 113 is struck by and fitted with one end portion 142a of a shaft portion 142 of a crown wheel 140 and a center portion 142b of the shaft portion 142 is fitted with a crown wheel 143 which is stopped from being drawn by a flange portion 142c at other end rotatably in E1, E2 directions around a center axis line C1. Further, the bearing holes 116, 136 are fitted with a shaft portion 192 of a crown transmission wheel 190 by way of bearings 191, 191 rotatably in M1, M2 directions around a center axis line M. The crown wheel 140 is brought in mesh with the winding pinion 121 by the crown gear 143 rotatably fitted to the shaft portion 142 and the crown transmission wheel 190 is brought in mesh with the crown wheel 143 by a crown transmission gear 193 mounted to the shaft portion 192. According to the example, in place of the constitution in which the crown wheel 40 is directly brought in mesh with the pivoting crown wheel 60 and the pivoting crown wheel 60 can be brought in mesh with the ratchet wheel 33 by way of the second transmission wheel 70 as in the embodiment of FIG. 1 through FIG. 3, the crown wheel transmission wheel 190 as the first gear structure member is brought in mesh with a pivoting crown wheel 160 as a second gear structure member capable of being directly brought in mesh with the crown wheel 133 as a third gear structure member by way of a crown transmission pinion 194 integral with the crown transmission wheel 193. Naturally, a combination of a train wheel may be similar to that of the timepiece 2 (naturally, conversely, a related train wheel of the timepiece 2 may be similar to the train wheel of the example).

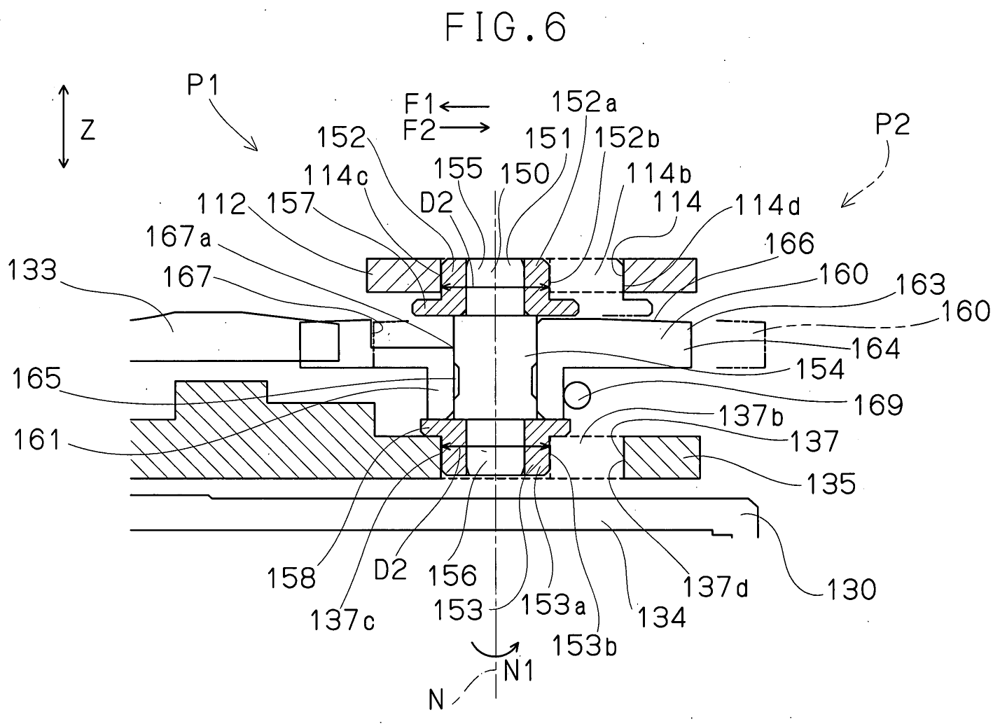

As is known from an enlarged sectional view of FIG. 6 in addition to FIG. 4 and FIG. 5, the circular arc shape long holes 114, 137 are loosely fitted with a shaft structure member 150 as a circular column shape pivoting member, the shaft structure member 150 is positioned by the circular arc shape long holes 114, 137 to rectify a range of pivoting the shaft structure member 150. The shaft structure member 150 includes a shaft member 151 comprising a material having high hardness and high wear resistance such as carbon steel, and boss members 152, 153 at both ends thereof comprising a material similar to that of the shaft member 151. The shaft member 151 includes a shaft main portion 154 at a center thereof and shaft attaching portions 155, 156 having small diameters at both end portions. The boss members 152, 153 respectively comprise cylindrical members having flange shape portions 157, 158 and fitted to the corresponding attaching shaft portions 155, 156. The role of the flange portions 157, 153 is similar to that of the flange shape portion 52 or the like of the hand winding mechanism 2. The boss members 152, 153 are loosely fitted to the long holes 114, 137 at circular cylinder shape main body portions 152a, 153a. Outer peripheral faces 152b, 153b of the circular cylinder shape main body portions 152a, 153a of the boss members 152, 153 are constituted by a shape and a size (diameter D2 and length) similar to those of the outer peripheral face of the circular cylinder shape main body portion 54 of the bearing 50 of the hand winding mechanism 1. One of the boss members 152, 153 may integrally be constituted by the shaft member 151.

According to the shaft structure member 150, the outer peripheral faces 152b, 153b of the circular cylinder shape main body portions 152a, 153a of the boss members 152, 153 can be rolled in a state of being brought into contact with outer peripheral side and inner peripheral side faces 114a, 137a (not illustrated, the same as follows) or 114b, 137b of the long holes 114, 137 along the peripheral faces 114a, 137a or 114b, 137b. Therefore, the shaft structure member 150 can be moved in F1, F2 directions between the one end portions 114c, 137c and other end portions 114d, 137d of the long holes 114, 137 along directions of extending the long holes 114, 137.

The pivoting crown wheel 160 as the second gear structure member includes a circular cylinder shape shaft portion 161 and a pivoting crown gear 163 integral with the shaft portion 161. The pivoting crown gear 163 includes a main body portion 164 comprising a circular plate shape member expanded in a flange-like shape on one end side of the shaft portion 161. The circular cylinder shape shaft portion 161 is fitted to the shaft main body portion 154 of the shaft structure member 150 by a center hole thereof, that is, a bearing receive hole 165 to be able to slidably rotate around a center axis line N as a second rotation center axis line. The circular plate shape main body portion 164 of the gear 163 of the pivoting crown wheel 160 includes an oil feeding recess portion 167 at a surface 166 disposed on a top side in assembling the timepiece 102, that is, on a case back side. As is known from FIG. 4 and FIG. 6, the recess portion 167 is provided with substantially a semicircular plane shape and an inner side edge portion 167a in the semicircular shape is continuous to the shaft receive hole 165. Further, the plane shape of the oil feeding recess portion 167 may be constituted by any other shape so far as the side edge 167a opened to the shaft receive hole 165 is provided without deteriorating a strength of the gear 163. Further, when the bearing receive hole 165 is opened at a surface on a dial side of the circular plate shape main body portion 164, the oil feeding recess portion 167 may be formed at the dial side surface. Further, the pivoting crown wheel 160 and the shaft structure member 150 constitute a pivoting crown wheel assembly or pivoting crown wheel structure member 106.

That is, according to the example, the pivoting crown wheel assembly 106 comprising the pivoting crown wheel 160 and the shaft structure member 150 is rectified in a pivoting range by the long holes 114, 137 positioned in a state of being interposed in the axial direction Z by the third bridge 112 and the barrel bridge 135 as a pair of pivoting members.

The pivoting crown wheel 160 can be pivoted in F1, F2 directions along the circular arc shape long holes 114, 137 along with the shaft structure 150 in a state of being brought in mesh with a pinion portion of the crown transmission wheel 190, that is, the crown wheel transmission pinion 194 in the pivoting crown wheel 163. When the shaft structure 150 is disposed at end portions 114c, 137c of the long holes 114, 137, the pivoting crown wheel 160 takes the mesh position P1 indicated by a bold line in FIG. 4 and FIG. 6 and the pivoting crown gear 163 of the pivoting crown wheel 160 is brought in mesh with the ratchet wheel 133 as the third gear structure member. On the other hand, when the shaft structure member 150 is disposed at end portions 114d, 137d of the long holes 114, 137, the shaft structure member 150 takes the nonmesh position P2 indicated by an imaginary line in FIG. 4 and FIG. 6 and the pivoting crown wheel 163 and the ratchet wheel 133 are released from being brought in mesh with each other.

The shaft portion 161 of the pivoting crown wheel 160 is exerted with an elastic deviation force in F1 direction by a pivoting crown spring 169. Further, the ratchet wheel 133 is brought in mesh with a second transmission wheel or second winding wheel (not illustrated) of the automatic winding mechanism 180 capable of rotating the ratchet wheel 133 in G1 direction.

Therefore, when the mainspring 131 is wound by rotating the ratchet wheel 133 in G1 direction by way of the second transmission wheel (not illustrated) by operating the automatic winding mechanism 180, in accordance with rotation of the ratchet wheel 133 in G1 direction, the pivoting crown gear 163 is pressed in F2 direction by the ratchet wheel 133 and therefore, against the spring force of the pivoting crown spring 169, the pivoting crown wheel 160 is pivoted from the mesh position P1 to the nonmesh position P2 in F2 direction along with the gear structure member 150 to actually release the pivoting crown wheel 163 and the ratchet wheel 133 from being brought in mesh with each other. Therefore, even when the crown wheel 140 or the like is brought into a nonrotating state, the ratchet wheel 133 is rotated in G1 direction without being restricted by the crown wheel 140 or the like and the ratchet wheel 133 can smoothly be driven to rotate and the mainspring 131 can smoothly be wound by the automatic winding mechanism 80.

Further, although the pivoting crown wheel 160 is more or less rotated around a center line N in pivoting in F2 direction by a force in F2 direction exerted to the pivoting crown wheel 163 by the ratchet wheel 133, since the pivoting crown wheel 160 is fitted to the shaft structure member 150 to be able to rotate slidably around the center axis line N and therefore, rotation of the pivoting crown wheel 160 does not actually rotate the shaft structure member 150 but pivoting (rolling) in F2 direction of the shaft structure member 150 can be carried out independently from rotation of the pivoting crown wheel 160 around the center axis line N and therefore, pivoting can smoothly be carried out.

That is, the pivoting crown wheel 160 is slidably fitted to the shaft structure member 150 and therefore, in displacing the pivoting crown wheel 160 in F2 direction, the pivoting crown wheel 160 can be slid to rotate around the center axis line of the shaft main body portion 154 independently from the displacement along the circular arc shape long holes 114, 137 of the shaft structure member 150 and therefore, the pivoting crown wheel 160 is easily displaced along the long holes 114, 137 along with the shaft structure member 150. Further, the shaft structure member 150 is loosely fitted to the long holes 114, 137 at the boss members 152, 153 and therefore, the shaft structure member 150 can be rolled along the peripheral walls 114a, 137a or 114b, 137b of the long holes 114, 137 (can be operated as a kind of a rolling bearing as in a wheel in view from the pivoting crown wheel 160) and therefore, the shaft structure member 150 can easily be displaced in F2 direction. As a result, in winding the mainspring 131 by the automatic winding mechanism 180, a resistance against transmission of a torque can be minimized and therefore, automatic winding is easily carried out efficiently. Further, a concern of wearing the peripheral walls 114a, 137a or 114b, 137b of the long holes 114, 137 is inconsiderable.

On the other hand, in a state in which a torque in G1 direction by the automatic winding mechanism 180 is not operated, the pivoting crown wheel 160 is displaced from the nonmesh position P2 to the mesh position P1 along with the shaft structure member 150 by the elastic deviation force in F1 direction of the pivoting crown spring 169. Therefore, when the winding stem 120 is rotated in B1 direction, in accordance with rotation in B1 direction of the winding stem 120, the crown transmission wheel 190 is rotated in M1 direction around the center axis line M by way of the clutch wheel 122, the winding pinion 121 and the crown wheel 140, and by rotation in N1 direction of the pivoting crown wheel 160 in accordance therewith, the ratchet wheel 133 is rotated in G1 direction to wind the mainspring 131.

Also in this case, the shaft structure member 150 can be pivoted or rolled in F1 direction and the pivoting crown wheel 160 can be rotated independently from each other and therefore, pivoting and rotation of respectives thereof can smoothly be carried out.

That is, the shaft structure member 150 in the mode of the circular column shape member is loosely fitted to the long holes 114, 137 by the boss members 152, 153 at both ends thereof and fitted to the bearing hole 165 of the pivoting crown wheel 160 to be able to rotate slidably by the shaft main body portion 154 at the center and therefore, in displacing the pivoting crown wheel 160 in F1 direction, the shaft structure member 150 can be rolled along the peripheral walls 114a, 137a or 114b, 137b of the long holes 114, 137 while being slidably rotated relative to the pivoting crown wheel 160 regardless of a meshed or rotated state of the pivoting crown wheel 160. Therefore, the shaft structure member 150 can easily be displaced without wearing the peripheral walls 114a, 137a or 114b, 137b of the long holes 14. Further, the pivoting crown wheel 160 is fitted to the shaft main body portion 154 of the shaft structure member 150 by the bearing hole 165 and therefore, the pivoting crown wheel 160 can slidably be rotated around the shaft structure member 150 to adapt to a mesh state or the like in accordance with the position of pivoting the shaft structure member 150 regardless of a position and a state of pivoting (rolling) the shaft structure member 150 and therefore, can smoothly be pivoted as a pivoting crown wheel assembly or the structure member 106 including the shaft structure member 150. As a result, when the mainspring 131 is stopped to be wound by the automatic winding mechanism 180, the pivoting crown wheel 160 is swiftly and firmly returned from the nonmesh position P2 to the mesh position in P1 hand winding, when the winding stem 120 is started to be rotated to wind in B1 direction, immediately, (in a state of minimizing consumption of initial rotation of the winding stem 120 for displacing the pivoting crown wheel 160 from the position P2 to the position P1), rotation of the winding stem 120 can be used for winding the mainspring 131 in G1 direction. Therefore, hand winding operation is easy to be carried out efficiently without waste.

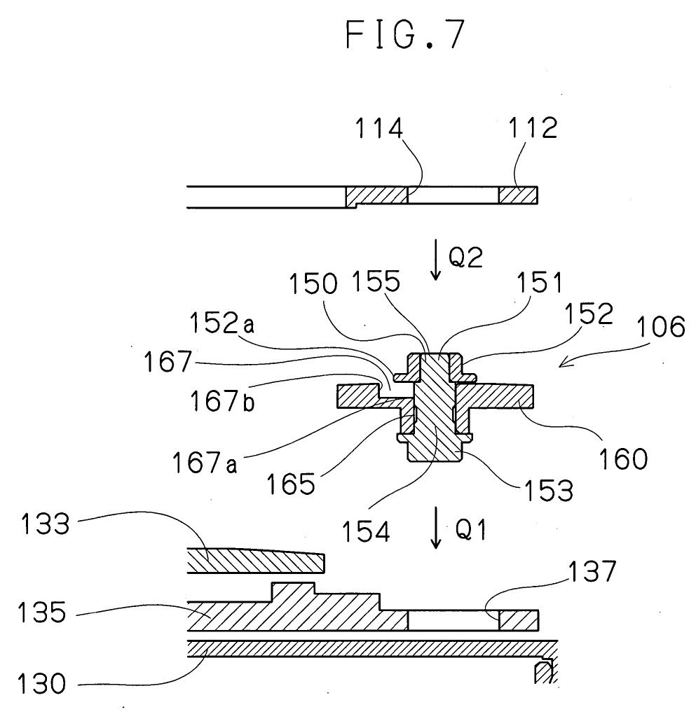

In assembling the timepiece 102 having the hand winding mechanism 101 having the above-described constitution, as shown by a disassembled or developed sectional view of related parts in FIG. 7, in a state of mounting the barrel 130 on the main plate (not illustrated), the pivoting crown wheel assembly 106 is inserted in Q1 direction to arrange such that the boss member 153 is loosely fitted to the long hole 137 of the barrel bridge 135, next, the third bridge 112 is moved in Q2 direction such that the long hole 114 is loosely fitted to the boss member 152 of the pivoting crown wheel assembly 106 and is assembled in a state shown in sectional views of FIG. 6 and FIG. 5.

Here, the pivoting crown wheel assembly 106 is constituted by integrating the shaft structure member 150 to the pivoting crown wheel 160, for example, formed by fitting the shaft main body portion 154 to the bearing hole 165 by inserting to fit the shaft member 151 of the shaft structure member 150 to the bearing hole 165 of the pivoting crown wheel 160 from a side of the one end 155, next, fitting the boss member 152 to the small diameter end portion 155 penetrating the bearing hole 165 to be projected therefrom. Further, for example, the shaft member 151 and the boss member 153 are previously fitted. However, as shown by FIG. 7, the shaft member 151 and the boss member 153 may previously be formed integrally. A previously integrally formed boss member may be the member 152 instead of the member 153.

According to the pivoting crown wheel assembly 106, an outer peripheral edge 167b of the oil feeding recess portion 167 of the pivoting crown wheel 160 is opened in a state of being expanded to an outer side in a diameter direction of an outer peripheral edge 152a of the boss member 152, and a face of the shaft main body portion 154 of the shaft member 151 of the shaft structure member 150 fitted to and brought into sliding contact with the shaft receive hole 165 of the sliding crown wheel 160 is continuous to the inner side edge 167a of the oil feeding recess portion 167 of the pivoting crown wheel 160 and therefore, by only feeding oil to the oil feeding recess portion 167, the oil can be fed to the face of the shaft main body portion 154 of the shaft member 151 of the shaft structure member 150 fitted to and brought into sliding contact with the shaft receive hole 165 of the pivoting ratchet wheel 160. Therefore, the oil may be fed in this way before assembling and the pivoting crown wheel assembly 106 may be assembled as described above.

In disassembling, a reverse procedure may be carried out. That is, by only removing the third bridge 112, the pivoting crown wheel assembly 106 can be removed, further, the barrel 130 and the main plate 111 can be removed as necessarily. That is, according to the timepiece 102 of the embodiment, different from the timepiece 2 of the previous embodiment shown in FIG. 1 and FIG. 2, the pivoting crown wheel assembly 106 is simply fitted loosely to the third bridge 112 and the barrel bridge 135 and therefore, the third bridge 112 and the barrel bridge 135 and the pivoting crown wheel assembly 106 can be handled as separate parts and therefore, parts can easily be interchanged.

Further, when disassembled to remove the third bridge 112 for repair or the like, the oil feeding recess portion 167 of the pivoting crown wheel assembly 106 is exposed and therefore, oil can be fed by way of the recess portion 167 as necessary.

What is claimed is:

1. A gear mechanism of a timepiece which is a gear mechanism of a timepiece comprising:
a first gear structure member having a first gear portion rotated around a first rotation center axis line;
a pivoting support member having a long hole extended in a shape of a circular arc centering on the first rotation center axis line;
a pivoting member in a circular shape an outer periphery of a cross-sectional face of which centers on a second center axis line and which is loosely fitted to the long hole rotatably centering on the second rotation center axis line and movably along the circular arc of the long hole;
a second gear structure member having a second gear portion fitted to the pivoting member to be able to rotate slidably and brought in mesh with the first gear portion; and
a third gear structure member having a third gear portion brought in mesh with the second gear portion when the pivoting member is disposed at a mesh position disposed on one end side of the long hole and released from being brought in mesh with the second gear portion when the pivoting member is disposed at a nonmesh position disposed on other end side of the long hole.

2. A gear mechanism of a timepiece according to claim 1, wherein the pivoting member comprises a bearing member which is a circular cylinder shape member centering on the second rotation center axis line and loosely fitted to the long hole movably along the circular arc of the long hole; and
wherein the second gear structure member includes a shaft portion fitted to a hole of a circular cylinder of the bearing member to be able to rotate slidably and fixed to the second gear portion.

3. A gear mechanism of a timepiece according to claim 1, wherein the second gear portion of the second gear structure member includes a bearing hole portion; and
wherein the pivoting member is a circular column shape member centering on the second axis line and includes a loosely fitted shaft portion loosely fitted to the long hole movably along the circular arc of the long hole and a gear shaft portion fitted to the bearing hole portion of the second gear portion of the second gear structure member.

4. A hand winding mechanism comprising:
a first gear structure member having a first gear rotated around a first rotation center axis line in accordance with rotation of a winding stem in one direction;
a pivoting support member having a long hole extended in a shape of a circular arc centering on the first rotation center axis line;
a pivoting member in a circular shape an outer periphery of a cross-sectional face of which centers on a second rotation center axis line and which is loosely fitted to the long hole rotatably centering on the second center axis line and movably along the circular arc of the long hole;
a pivoting crown wheel which is a second gear structure member including a pivoting crown gear fitted to the pivoting member to be able to rotate slidably and constituting a second gear portion brought in mesh with the first gear portion; and
a third gear structure member including a third gear portion brought in mesh with the pivoting crown gear when the pivoting member is disposed at a mesh position disposed on one end side of the long hole and released from being brought mesh with the pivoting crown gear when the pivoting member is disposed at a nonmesh position disposed on other end side of the long hole and coupled to a ratchet wheel.

5. A hand winding mechanism according to claim 4, wherein the pivoting member comprises a bearing member which is a circular cylinder shape member centering on the second rotation center axis line and loosely fitted to the long hole movably along the circular arc of the long hole; and
wherein the pivoting crown wheel includes a shaft portion fitted to a hole of a circular cylinder of the bearing member to be able to rotate slidably and fixed to the pivoting crown gear.

6. A hand winding mechanism according to claim 4, wherein the pivoting crown gear of the pivoting crown wheel includes a bearing hole portion; and
wherein the pivoting member is a circular column shape member centering on the second rotation center axis line and includes a loosely fitted shaft portion loosely fitted to the long hole movably along the circular arc of the long hole and a gear shaft portion fitted to the bearing hole portion of the pivoting crown gear to be able to rotate slidably.

7. A hand winding mechanism according to claim 4, wherein the first gear structure member comprises a crown wheel, the first gear portion comprises a crown gear, the third gear portion comprises a transmission gear brought in mesh with a ratchet gear, and the third gear structure comprises a transmission wheel.

8. A hand winding mechanism according to claim 4, wherein the first gear portion comprises a transmission gear brought in mesh with the crown gear, the first gear structure member comprises a transmission wheel, and the third gear portion comprises a ratchet gear of a ratchet wheel.

9. A timepiece comprising the hand winding mechanism according claim 4.

10. A timepiece according to claim 9, further comprising an automatic winding mechanism for rotating the ratchet wheel in a winding direction.
